(19) United States
(12) Patent Application Publication
(10) Pub. No.: US 2019/0073847 A1
(43) Pub. Date: Mar. 7, 2019

(54) System for Unlocking a Lock of a Space that Needs to be Secured

(71) Applicants: KTS Kommunikationstechnik Und Systeme GmbH, Mönchengladbach (DE); Berthold Sichert GmbH, Berlin (DE)

(72) Inventors: Gregor Kotyrba, Willich (DE); Tim Seidel, Aldenhoven (DE); Mirko Hüller, Klein Welzin (DE)

(21) Appl. No.: 16/085,471

(22) PCT Filed: Mar. 13, 2017
(86) PCT No.: PCT/EP2017/055799

§ 371 Date: Sep. 14, 2018

(30) Foreign Application Priority Data
Mar. 15, 2016 (EP) 16160339.4

(51) Int. Cl. G07C 9/00

(52) U.S. Cl. CPC G07C 9/00174; G07C 2009/00634

(57) ABSTRACT

The invention relates to a system for unlocking a lock of a space that needs to be secured, in particular an appliance or electrical cabinet (1), in which system, in the locked state of the lock, an electromagnetically drivable bolt (5, 6, 7) can be moved from a state in which it locks the lock to a state in which it releases the lock by applying an electrical voltage, wherein the lock is arranged in the interior of the space and is provided with a code storage device (8) which allows the bolt (5, 6, 7) to be operated only when a code which is stored in the code storage device (8) matches a key code which is wirelessly transmitted from outside the space, via the space wall, to the code storage device (8). According to the invention, an energy receiving device(7) is arranged in the interior of the space, it being possible for electrical energy to be supplied to said energy storage device from the outside the space by inductive transmission via the space wall from an eternal energy source which provides electrical energy for operating the bolt (5, 6, 7) before the lock can be released when the code which is stored in the code storage device (8) matches the key code which is transmitted via the space wall.

The invention relates to a system for unlocking a lock of a space that needs to be secured, in particular an appliance or switchgear cabinet, according to the preamble of claim 1.

The locking and unlocking of spaces to be secured are usually effected by means of a lock that can be released or blocked with a key. To this end, each user of the lock requires a key, so that, in the case of a plurality of users, generally a corresponding number of keys must be available. In the event of loss of a key, the lock cylinders used should therefore be changed in safety-critical locks, so that new keys can be made for all users.

In recent years, electronic locks have also been disclosed which make it possible to actuate the lock by entering a code on a keyboard, so that access is possible for all persons who know the code. A change of the code required for various reasons is possible in a simple manner and only requires the authorized persons be informed of the new code.

In other keyless access systems, chip cards having stored codes are used instead of keys. Such a system means that just knowing the code is not enough to actuate a lock. Chip cards can be replaced in a simple manner as required, or in the case when programmable chip cards are used, they can be reprogrammed.

Since electronic locks only require a code transmission for unlocking, it is necessary to continue to mechanically execute the actual lock release. This can be effected either by an actuating handle which is arranged on the outside of the space, which releases a locking bolt after an authorization code has been input, or by means of an electromagnetically controllable bolt which is actuated as soon as there is a release from a control circuit enabled by the electronic key.

In an electronic locking system, therefore, in every case it is necessary on the one hand to supply electrical energy to supply the necessary code storage device with electricity for releasing the lock, or on the other hand to drive a locking bolt in the event of an electrical actuation.

It is known to supply energy to electronic locks from batteries, accumulators or even photovoltaic elements. In frequent operation, however, batteries or accumulators are quickly depleted, in particular, if they are used outdoors at low temperatures, so that frequently it happens that such that a lock can no longer be actuated because of the lack of energy. The use of photovoltaic energy is restricted to illuminated locations.

If low-voltage energy is available in a space, such as an electrical cabinet, energy for operating the lock can be diverted therefrom, but this should be avoided as far as possible, since this results in external use, which is often not permissible for reasons of contract law. In the case of an electrical cabinet for high-voltage energy, the use of this energy for low-current purposes is forbidden in any case for technical reasons.

Many spaces to be secured that are used outdoors contain telecommunication devices, which are operated without current, in particular fiber optic distribution boxes. In this case, there is no possibility of using existing energy. In addition, mail distribution boxes are not connected to an electrical energy supply. Nevertheless, such boxes must useable by a plurality of persons who are authorized, in a corresponding box, to perform maintenance tasks or, in the case of mail distribution boxes, to insert items of mail into the cabinet or to remove them therefrom. These authorizations must be restricted to specific boxes or to a limited amount of time. The authorizations must also be constantly updated in accordance with a security plan. The use of simple mechanical lock arrangements is too complicated and unreliable for these purposes.

The object of the invention is therefore to provide a system for unlocking a lock on a space to be secured, in particular an appliance or electrical cabinet which has an electronic security system, which does not require energy storage or connection an energy supply, and which can be flexibly adjusted to changing security requirements.

This object is achieved by the invention specified in claim 1. Advantageous further modifications of the invention are specified in the dependent claims.

The invention relates to a system for unlocking a lock on a space to be secured, in particular a device or electrical cabinet, in which, in the locked state of the lock, an electromagnetically drivable bolt can be transferred from a state locking the lock to a state releasing the lock by applying an electric voltage, wherein the lock is arranged in the interior of the space and is provided with a code storage device. The latter allows the bolt to be actuated only if a code stored in the code storage device matches a code wirelessly transmitted from outside the space through the space wall to the code storage device.

The invention combines an electronic lock with an electromagnetically drivable bolt with a locking and unlocking circuit, wherein the energy required for this purpose is temporarily received wirelessly from an external energy supply source. The system is therefore a purely passive system which only becomes active when energy is transmitted from outside to the interior of the space through the wall of the space. However, the unlocking of the lock using this energy can only take place when a key code matches a code stored in the interior of the space in a code storage device.

As soon as the energy source from the space wall is removed, the circuit present in the interior of the space again returns to the passive state, so that the space is blocked again.

Preferably, the electrical energy supplied from outside the space to the interior is buffered in a buffer storage. This makes it possible to remove the energy source from the space wall if necessary, even after brief charging of the buffer, and before the code to unlock the lock is transmitted. A storage capacitor is preferably used as the buffer storage.

In order to be able to compare the key code of the key carried by the user with the code stored in the code storage device inside the space, the key code is transmitted via a wireless near-field connection. Said near-field connection can preferably be a\RFID transponder connection, an NFC connection, or a Bluetooth connection. A near field connection via RFID or NFC is preferred, in order to be able to limit the range of a code transmission to a short distance, e.g. in the centimeter range.

In order to be able to transmit energy from the energy source to the energy receiving device arranged in the interior of the space, the energy source is preferably temporarily fastened to the outside of the space at a specific location by means of a holding magnet. This has the advantage that the energy source, by appropriate localization of the holding magnet, can be held precisely at the location where the energy receiving device is located in the interior of the space. The energy transmission device is preferably designed according to the QI transmission system, which allows the transmission of electrical energy by means of two transformer coils which are aligned in parallel to one another.

The energy source used on the outside of the space can also at least temporarily transmit electrical energy to the key, if the latter does not have its own energy source. Preferably, the key and the energy source therefore form a unit, so that the user has to carry out only one device unit.

So that the energy transmission between the energy source and the energy storage unit on the one hand and the transmission of the code between the key and the code storage unit on the other do not mutually influence each other, the energy and the key code are preferably transmitted alternately or over different frequency channels.

The mechanical part of the locking system preferably consists of one or more locks in the interior of the space, which are electromagnetically actuated when released by the code storage device. The bolts can also be actuated by an outside handle, as soon as a lock in the interior of the space is released by the code storage device. The bolt or bolts are preferably spring-loaded, so that in the passive state of the lock system they are in the locking position or fall back thereto, in order to avoid unintentionally leaving the lock of the space door unlocked.

For documentation purposes, all switching operations, opening operations, user identifications, etc. are permanently or temporarily stored in a protocol memory in the code storage device. From said storage device, they can preferably be electronically read out or evaluated by means of a separately secured communication connection. The read-out can be effected via a USB connection or also wirelessly, wherein in the latter case opening of the space is not required.

The invention is explained in more detail below with reference to an exemplary embodiment. Wherein:

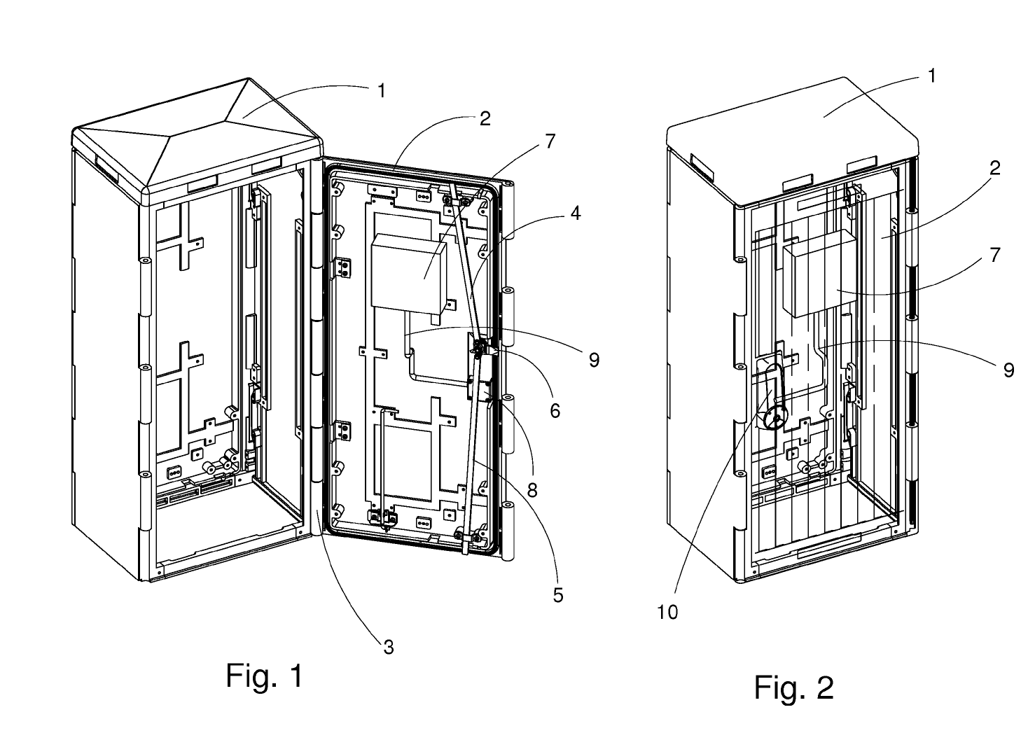

FIG. 1 a cable distributor of telecommunications technology with a locking system according to the invention with opened door.

FIG. 2 a cable distributor with a transparent door in locked state,

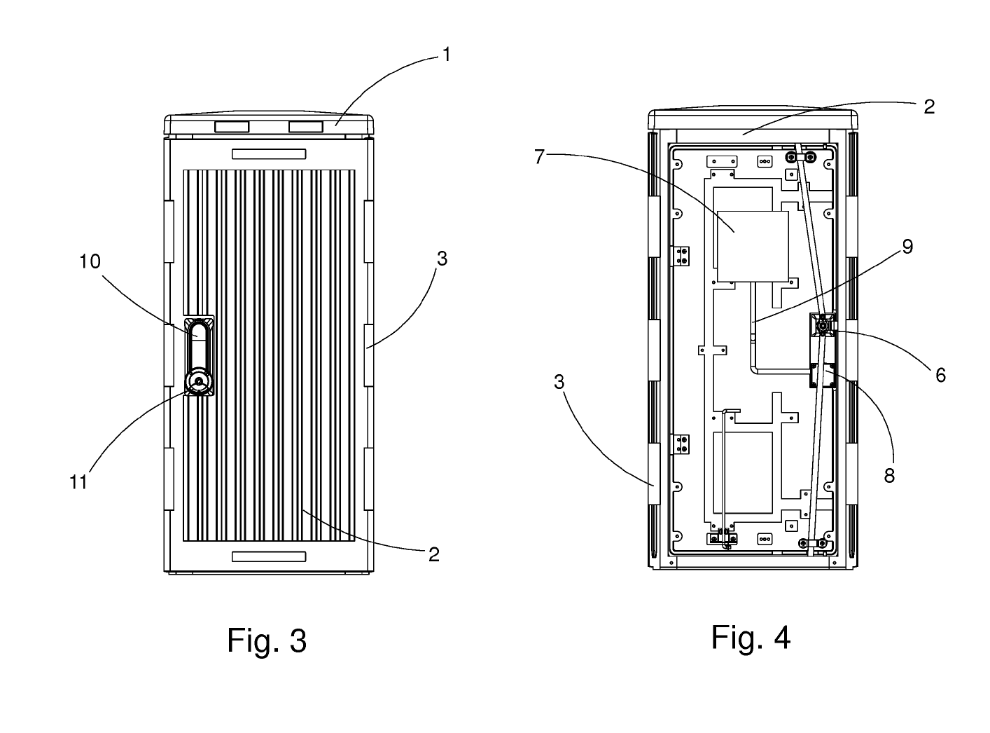

FIG. 3 a front view of a cable distributor with closed door, and

FIG. 4 an inner view of a door with a locking system according to the invention.

FIG. 1 shows a space that must be locked, which for example is designed as a cable distributor of telecommunications technology. The term “space that must be secured” may also be understood as other types of spaces that have a locking door, in which the interior of the space must be secured against unauthorized entry or access. These include devices or electrical cabinets for telecommunications devices, for energy supply, or for mail transmissions. The invention may be used especially usefully for spaces that do not contain their own power supply and which are in the open, wherein they are exposed to changing environmental conditions, such as high or low temperatures. The invention is therefore especially suited for cable distributors of communications technology, over which purely passive optical waveguide connections are produced, which are de-energized. If the space to be secured can already be supplied with energy in some other way, the temporary energy transmission is unremarkable.

Such a cabinet 1 is generally anchored securely to the ground and has a door 2 which can be blocked by means of displaceable or pivotable bolts 4, 5, and 6, wherein the door 2 is connected by a hinge 3 to a cabinet edge.

On the inside of the door there is an energy receiving device 7 and a code storage device 8, which are connected to one another via a connecting line 9. The door material is preferably breakproof plastic or metal, wherein with a metal door, the region of the door 2 to which on the onside the energy receiving device 7 is located is preferably made of plastic.

FIG. 2 shows a corresponding cabinet view the door closed, wherein the door is shown in a semitransparent manner. On the outside of the door there is only the locking part 10 with handle 11, as is also shown in FIG. 3. The location of the energy receiving device 7 is therefore not discernible from outside.

FIG. 3 shows the closed cabinet.

The inside of the door is shown again in FIG. 4. Actuation of the locking system takes places as follows:

Each authorized user has a mobile energy source, for example an accumulate or battery storage unit which is provided with a charging coil which can inductively transmit electrical energy to an energy receiving device located in the near field of the coil. The principle of such energy transmission has become known under the name QI, particularly for mobile telephones and tablets. The QI principle uses a resonant inductive coupling between transmitter and receiver. Apart from a QI transmission technology, similarly operating competing systems are known, which each basically use a transmission coil or a receiving coil, which are arranged in parallel to one another, and also have a communication connection so as to monitor the energy transmission.

In order to determine the site on the inside of the door where the energy receiving device 7 is located from the outside, on the inside of the door at the point of the energy receiving device there is a magnet which acts on a magnetizable plate on the energy source. Conversely, the magnet may be arranged on the energy source. The magnetic holder thereby produced ensures that the energy source can be placed precisely on the point on the cabinet door where, on the inside, the energy receiving device 7 is located. A further advantage of the magnet is that the energy source can be held securely on the cabinet door without the user having to constantly hold onto it.

The electrical energy received by the energy receiving device 7 is transmitted over the connecting line 9 to the code storage device 8. The code storage device 8 contains a circuit that evaluates a code sent from outside the cabinet with a code stored in the code storage device, if they agree issues the unlock signal which can electromagnetically release a locking latch, so that then the sliding bolts 4 and 5 as well as the pivoting bolt 6 can be actuated as long as sufficient energy is transmitted from the energy source or is made available from buffer storage. The actuation of the bolts can occur either directly, by means of electromagnets, or also by mechanical actuation of the handle 11 on the outside of the door, which may be actuated after release of the locking latch in the interior of the cabinet. With mechanical actuation of the handle 11, less energy is required, so that less electrical energy must be transmitted via the energy receiving device 7.

The transmission of the release code between the key carried by the user to the code storage device 8 takes place independently of energy transmission, preferably by means of an RFID transmission, a Bluetooth transmission, an NFC transmission (near field communication) or also a wireless LAN transmission (WLAN), wherein an RFID or NFC transmission is preferred.

The transmission of the key code to the interior of the cabinet requires only a small amount of energy, which can be made available from button cells of the key. However, the key and the external energy source can also form a unit, so that the radio transmission module of the key can also be supplied from the external energy source.

So as not to interfere with the transmission of the key code by the energy transmission to the energy receiving device 7, the transmission of the code and the energy transmission to the energy receiving device 7, preferably in alternation or by using different, mutually non-interfering frequency channels. The corresponding control of the exchange or the determination of the frequency channels to be used can be done by the control circuit of the external energy source.

In order to limit use of the electronic key, each cabinet can have a unique identifier and further attributes, which are stored in the code storage device, in particular in an RFID transponder located therein. It is thus possible to assign a key exclusively to a specific cabinet or a group of cabinets. Further attributes can be used to access the cabinet only for certain keys, for example maintenance keys or master keys. The keys can also be assigned a limited validity period. When the key is lost, there is therefore only a slight potential for abuse.

In order to determine which key has access to the respective cabinet at which point in time, the code storage device can also contain a protocol memory, which can be read out via a master key, e.g. via a Bluetooth connection or an internal USB connection. A program app set up on a smartphone or a tablet is particularly suitable for configuring and reading out the code storage device.

The system according to the invention is particularly suitable for passive spaces, in particular cable distributors of communication technology or distribution cabinets for mail items. The spaces do not require a built-in energy source or a permanently installed voltage supply.

In addition to the aforementioned spaces, the invention is also suitable in principle for accessible spaces with access doors, in particular when the latter are to be secured in a particularly secure manner and no energy source is available for the electrical actuation of the lock.

### REFERENCE SYMBOLS

1. Cabinet
2. Door
3. Hinge
4. Sliding bolt
5. Sliding bolt
6. Pivoting bolt
7. Energy receiving device
8. Code storage device
9. Connecting line
10. Locking part
11. Handle

1. A system for unlocking a lock on a space that must be secured, in particular an appliance or electrical cabinet (1) in which in the locked state of the lock, an electromagnetically drivable bolt (5, 6, 7) can be transferred from a state locking the lock to a state releasing the lock by applying an electric voltage, wherein the lock is arranged in the interior of the space and is provided with a code storage device (8) which allows the bolt (5, 6, 7) to be actuated only if a code stored in the code storage device (8) matches a key code wirelessly transmitted from outside the space through the space wall to the code storage device (8), characterized in that an electromagnetic energy receiving device (7) is arranged in the interior of the space, to which electrical energy can be supplied from outside the space by means of inductive transmission via the space wall from an outside energy source, which makes electrical energy available for actuating the bolt (5, 6, 7) before the lock can be released upon matching of the code stored in the code storage device (8) with the key code transmitted via the space wall.

2. The system according to claim 1, characterized in that the electrical energy supplied from outside the space is stored in a buffer.

3. The system according to claim 1, characterized in that the wireless communication between the code storage device (8) and the key takes place by means of a near field connection, in particular an RFID transponder connection, an NFC connection, or a Bluetooth connection.

4. The system according to claim 1, characterized in that a holding magnet is arranged on the energy source or space wall, by which the energy source on the outside of the space can be arranged and held on a point on the space wall where the energy receiving device (7) is located on the inside of the space.

5. The system according to claim 1, characterized in that the energy source also transmits energy to the key, at least temporarily.

6. The system according to claim 1, characterized in that the key and the energy source form a unit.

7. The system according to claim 1, characterized in that the transmission of the key code and the electrical energy occur alternately or via different frequency channels.

8. The system according to claim 1, characterized in that the bolt (5, 6, 7) is spring-loaded and releases the lock (10) only as long as electrical energy is available to drive the bolt (5, 6, 7).

9. The system according to claim 1, characterized in that the code storage device (8) is provided with a readable protocol memory.

10. The system according to claim 5, characterized in that the key and the energy source form a unit.
